(19) United States
(12) Patent Application Publication
(10) Pub. No.: US 2009/0310822 A1
(43) Pub. Date: Dec. 17, 2009

(54) Feedback object detection method and system

(75) Inventors: Chih-Hao Chang, Chung-Ho (TW); Zhong-Lan Yang, Chung-Ho (TW)

Correspondence Address: LIU & LIU, 444 S. FLOWER STREET SUITE 1750, LOS ANGELES, CA, 90071, US

(73) Assignee: VATICS, INC.

(21) Appl. No.: 12/456,186

(22) Filed: Jun. 11, 2009

(30) Foreign Application Priority Data
Jun. 11, 2008 (TW) 097121629

(51) Int. Cl. G06K 9/00

(52) U.S. Cl. 382/103

(57) ABSTRACT

A feedback object detection method and system. The system includes an object segmentation element, an object tracking element and an object prediction element. The object segmentation element extracts the object from an image according to prediction information of the object provided by the object prediction element. Then, the object tracking element tracks the extracted object to generate motion information of the object like moving speed and moving direction. The object prediction element generates the prediction information such as predicted position and predicted size of the object according to the motion information. The feedback of the prediction information to the object segmentation element facilitates accurately extracting foreground pixels from the image.

### FIELD OF THE INVENTION

The present invention relates to an object detection method and system, and more particularly to an object detection method and system using feedback mechanism in object segmentation.

### BACKGROUND OF THE INVENTION

Nowadays, image processing is applied to many systems. It covers many technological fields. Object detection is one rapidly developed subject of the technological fields, and capable of getting a lot of information from images. The most important concept of object detection is to extract object from images to be analyzed, and then track the changes in appearances or positions of the objects. For many applications such as intelligent video surveillance system, computer vision, man-machine communication interface, image compression, it is of vital importance.

Compared with the conventional video surveillance system, the intelligent video surveillance systems adopting object detection may economize manpower for the purpose of monitoring the systems every moment. The requirement of accuracy of object detection tends to increase to improve the monitor efficiency. If the accuracy can reach a satisfying level, many events, for example dangerous article left over in public place or suspicious character loitering around guarded region, can be detected, recorded and alarmed automatically.

Please refer to FIG. 1, a functional block diagram illustrating a conventional object detection system. The conventional object detection system basically includes three elements—object segmentation element 102, object acquisition element 104 and object tracking element 106. The images are firstly inputted to the object segmentation element 102 to obtain a binary mask in which the foreground pixels are extracted from the image. Then, the binary mask is processed by the object acquisition element 104 to collect the features of the foreground pixels and grouping related foreground pixels into objects. A typical method to acquire objects is connected component labeling algorithm. At last, the objects in different images are tracked by the object tracking element 106 to realize their changes in appearances or positions. The analysis results are outputted and the object information such as object speed, object category and object interaction is thus received.

There are some approaches proposed for the object segmentation. FIGS. 2A˜2C illustrate three of these approaches: frame difference, region merge, and background subtraction, respectively.

### (1) Frame Difference (FIG. 2A):

This approach compares the pixel information including color and brightness of each pixel in the current image with that of the previous image. If the difference is greater than a predetermined threshold, the corresponding pixel is considered as a foreground pixel. The threshold value affects the sensitivity of the segmentation. The calculation of this approach is relatively simple. One drawback of this approach is that the foreground object cannot be segmented from the image if it is not moving.

### (2) Region Merge (FIG. 2B):

In this approach, pixels are compared with the nearby pixels to calculate the similarity. After a certain calculation, pixels having similar properties are merged and segmented from the image. The threshold value or sensitivity affects the similarity variation tolerance in the region. No background model is required for this approach. The calculation is more difficult than the frame difference approach. One drawback of this approach is that only object having homogenous feature can be segmented from the image. Further, an object is often composed of several different parts with different features.

### (3) Background Subtraction (FIG. 2C):

This approach establishes a background model based on historical images. By subtracting the background model from the current image, the foreground object is obtained. This approach has the highest reliability among the three approaches and is suitable for analyzing images having dynamic background. However, it is necessary to maintain the background model frequently.

False alarm is an annoying problem for the above-described object segmentation methods since only pixel connection or pixel change is considered. Local change such as flash or shadow affects the object segmentation very much. Besides, noise is probably considered as a foreground object. These accidental factors trigger and increase false alarms. These problems are sometimes overcome by adjusting the threshold value or sensitivity. The determination of the threshold value or sensitivity is always in a dilemma. If the threshold value is too high, the foreground pixels cannot be segmented from the image when the foreground pixels are somewhat similar to the background pixels. Hence, a single object may be separated into more than one part in the object segmentation procedure if some pixels within the object share similar properties with the background pixels. On the other hand, if the threshold value is too low, noise and brightness variation are identified as foreground objects. Hence, the fixed threshold value does not satisfy the accuracy requirement for the object segmentation.

Therefore, there is a need of providing an efficient object detection method and system to reduce the frequency of false alarm. In particular, controllable threshold values and sensitivities may be considered to achieve smart object detection.

### SUMMARY OF THE INVENTION

The present invention provides a feedback object detection method to increase accuracy in object segmentation. According to the feedback object detection method, the object is extracted from an image based on prediction information of the object. Then, the extracted object is tracked to generate motion information such as moving speed and moving direction of the object. From the motion information, another prediction information is derived for the analysis of the next image.

In an embodiment, the threshold value for each pixel in the extracting step is adjustable. If one pixel is a predicted foreground pixel, the threshold value of the pixel decreases. On the contrary, if one pixel is a predicted background pixel, the threshold value of the pixel increases.

A feedback object detection system is also provided. The system includes an object segmentation element, an object tracking element and an object prediction element. The object segmentation element extracts the object from the first image according to prediction information of the object provided by the object prediction element. Then, the object tracking element tracks the extracted object to generate motion information of the object such as moving speed and moving function. The object prediction element generates the prediction information of the object according to the motion information. In an embodiment, the prediction information indicates the possible position and size of the object to facilitate the object segmentation.

In an embodiment, the system further includes an object acquisition element for calculating object information of the extracted object by performing a connected component labeling algorithm on the foreground pixels. The object information may be color distribution, center of mass or size of the object. Then, the object tracking element tracks the motion of the object according to the object information derived from different images.

An object segmentation method is further provided to analyze an image consisting of a plurality of pixels, a portion of which constitutes an object. Prediction information of the object such as predicted position and predicted size is provided, and segmentation sensitivity for each pixel is adjusted according to the prediction information. Each pixel is determined to be a foreground pixel or a background pixel according to its property and the corresponding segmentation sensitivity.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram illustrating the conventional object detection system;

FIGS. 2A˜2C illustrate three types of known object segmentation procedures applied to the object segmentation element of FIG. 1;

FIG. 3 is a functional block diagram illustrating a preferred embodiment of a feedback object detection system according to the present invention;

FIG. 4 is a flowchart illustrating an object segmentation procedure according to the present invention; and

FIG. 5 is a flowchart illustrating an object prediction procedure according to the present invention.

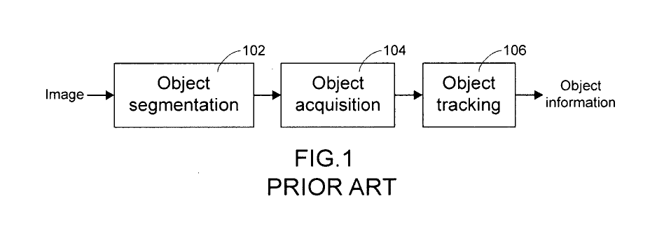

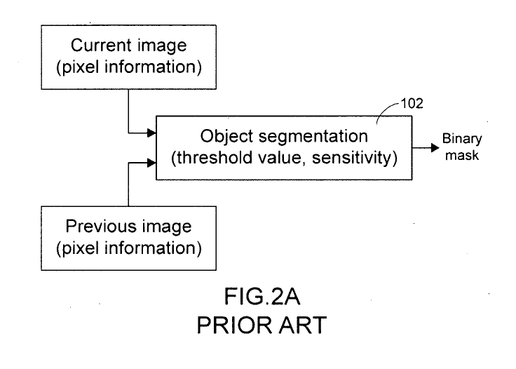

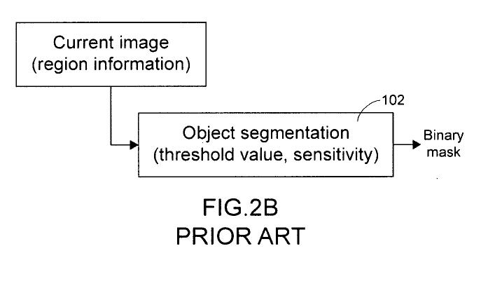

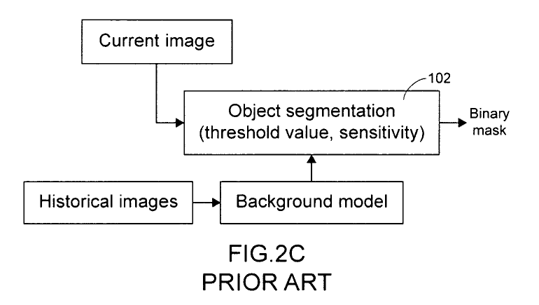

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

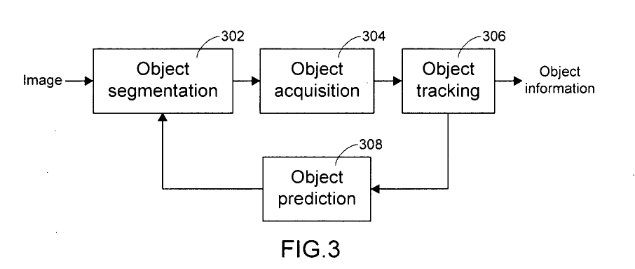

Please refer to FIG. 3, a functional block diagram illustrating a feedback object detection system according to the present invention. The feedback object detection system includes one element, object prediction element 308, more than the conventional object detection system. The object prediction element 308 generates prediction information of objects to indicate the possible positions and sizes of the objects in the next image. Accordingly, the object segmentation element 302 obtains a binary mask by considering the current image and the prediction information of the known objects. If one pixel is located in the predicted regions of the objects, the object segmentation element 302 increases the probability that the pixel is determined as a foreground pixel in the current image. The pixels in the current image may be assigned with different segmentation sensitivities to obtain a proper binary mask which accurately distinguishes the foreground pixels from the background pixels.

Then, the binary mask is processed by the object acquisition element 304 to collect the features of the foreground pixels and group related foreground pixels into objects. A typical method for acquiring objects is connected component labeling algorithm. At this stage, the feature of each segmented object, for example color distribution, center of mass and size, is calculated. At last, the objects in different images are tracked by the object tracking element 306 by comparing the acquired features of corresponding objects in sequential images to realize their changes in appearances and positions. The analysis results are outputted and the object information such as object speed, object category and object interaction is thus received. The analysis results are also processed by the object prediction element 308 to get the prediction information for the segmentation of the next image.

Compared with the conventional object segmentation procedure, the sensitivity and the threshold value for object segmentation according to the present invention become variable in the entire image. If the pixel is supposed to be a foreground pixel, the threshold value for this pixel is decreased to raise the sensitivity of the segmentation procedure. Otherwise, if the pixel is supposed to be a background pixel, the threshold value for this pixel is increased to lower the sensitivity of the segmentation procedure.

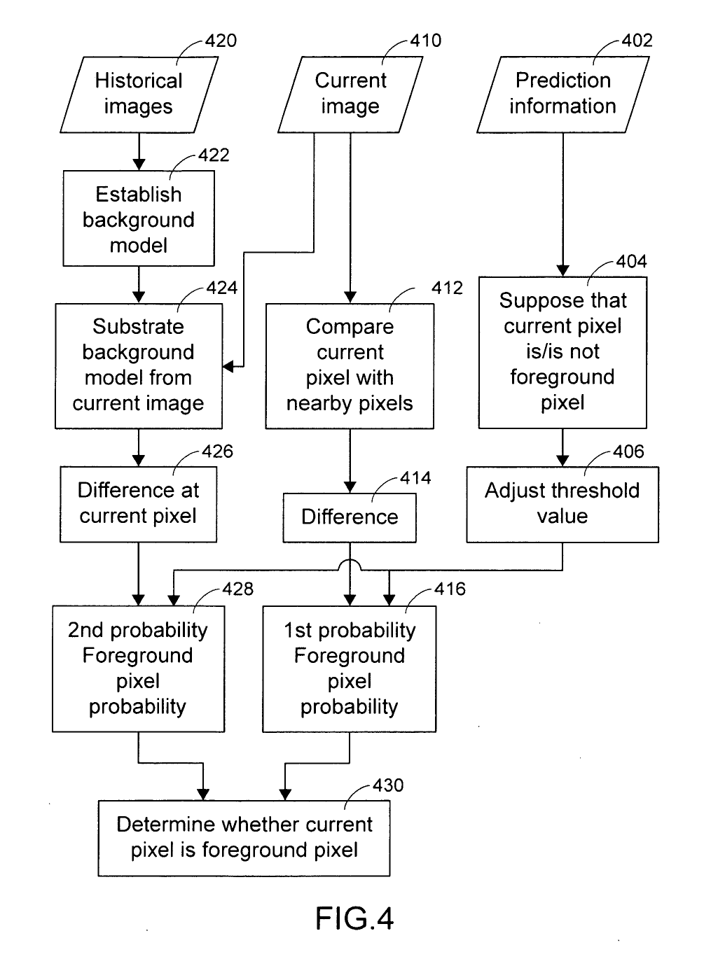

As mentioned above, there are three known approaches for the object segmentation, including frame difference, region merge, and background subtraction. The variable threshold value and sensitivity of the present invention can be used with one, all, or combination of these approaches. FIG. 4 is a flowchart illustrating the object segmentation procedure for one pixel using the variable threshold value (sensitivity) and the later two of these approaches. This embodiment is just for description, but not limiting the scope of the invention. For example, the variable threshold value (sensitivity) may be applied to only background subtraction without the other two.

At step 402, the prediction information is inputted to the object segmentation element. According to the prediction information such as object positions and object sizes, the current pixel is preliminarily determined as a predicted foreground pixel or a predicted background pixel (step 404). If it is supposed that the current pixel is a foreground pixel, the threshold value of the pixel is decreased to raise the sensitivity. On the other hand, if it is supposed that the current pixel is a background pixel, the threshold value is increased to lower the sensitivity (step 406).

Steps 410˜416 correspond to region merge approach. After the input of the current image (step 410), the current pixel is compared with nearby pixels (step 412). The similarity variation between the current pixel and the nearby pixels is obtained after a certain calculation (step 414). Then, the similarity variation is compared with the adjusted threshold value to find out a first probability of that the current pixel is the foreground pixel (step 416). Accordingly, this path from step 410 to step 416 is a spatial based segmentation.

Steps 420˜428 correspond to background subtraction approach. Historical images are analyzed to establish a background model (steps 420 and 422). The background model may be selected from a still model, a probability distribution model, and a mixed Gaussian distribution model according to the requirements. The established background model is then subtracted from the current image to get the difference at current pixel (steps 424 and 426). The difference is compared with the adjusted threshold value to find out a second probability of that the current pixel is the foreground pixel (step 428). Accordingly, this path from step 420 to step 428 is a temporal based segmentation.

At last, the procedure determines at step 430 whether the current pixel is a foreground pixel by considering the probabilities obtained at steps 416 and 428. The adjustable threshold value obtained at step 406 significantly increases the accuracy in the last determination. The procedure repeats for all pixels till the current image is completely analyzed to obtain a binary mask for the object acquisition element.

According to the present invention, the object segmentation procedure can solve the problems incurred by the prior arts. First of all, the object is not segmented into multiple parts even some pixels within the object has similar feature as the background. The decrease of threshold value of these pixels can compensate this phenomenon. Secondly, the reflected light or shadow does not force the background pixels to be segmented as foreground pixels since the increase of threshold value reduce the probability of misclassifying them as foreground pixels. Finally, if one object is not moving, it is still considered as a foreground object rather than be learnt into the background model.

From the above description, the object prediction information fed back to the object segmentation element affects the controllable threshold value very much. Some object prediction information is explained herein. The object prediction information may include object motion information, object category information, environment information, object depth information, interaction information, etc.

Object motion information includes speed and position of the object. It is basic information associated with other object prediction information.

Object category information indicates the categories of the object, for example a car, a bike or a human. It is apparent that the predicted speed is from fast to slow in this order. Furthermore, a human usually has more irregular moving track than a car. Hence, for a human, more historical images are required to analyze and predict the position in the next image.

Environment information indicates where the object is located. If the object is moving down a hill, the acceleration results in an increasing speed. If the object is moving toward a nearby exit, it may predict that the object disappear in the next image and no predict position is provided for the object segmentation element.

Object depth information indicates a distance between the object and the video camera. If the object is moving toward the video camera, the size of the object becomes bigger and bigger in the following images. On the contrary, if the object is moving away from the video camera, the object is of smaller and smaller size.

Interaction information is high-level and more complicated information. For example, one person is moving behind a pillar. The person temporarily disappears in the images. The object prediction element can predict the moving after he appears again according to the historical images before his walking behind the pillar.

The object motion information is taken as an example for further description. The position and motion vector of object k at time t is respectively expressed as Pos(Obj(k), t) and MV(Obj(k), t).

MV(Obj(k), t)=Pos(Obj(k), t)−Pos(Obj(k), t−1) (1)

A motion prediction function MP(Obj(k), t) is defined as:

MP(Obj(k), t)=(MV(Obj(k), t)+MV(Obj(k), t−1)+MV(Obj(k), t−2)+ . . . )_{low}_{_{—}}ₚₐₛₛ (2)

A low pass filter is used in the above equation to filter out the possible irregular motion. Accordingly, the predicted position of the object Predict_pos(Obj(k), t+1) may be obtained by adding the motion prediction function to the current position as the following equation:

Predict_pos(Obj(k), t+1)=Pos(Obj(k), t)+MP(Obj(k), t) (3)

Thus, pixels within the prediction region of the object are preliminarily considered as foreground pixels.

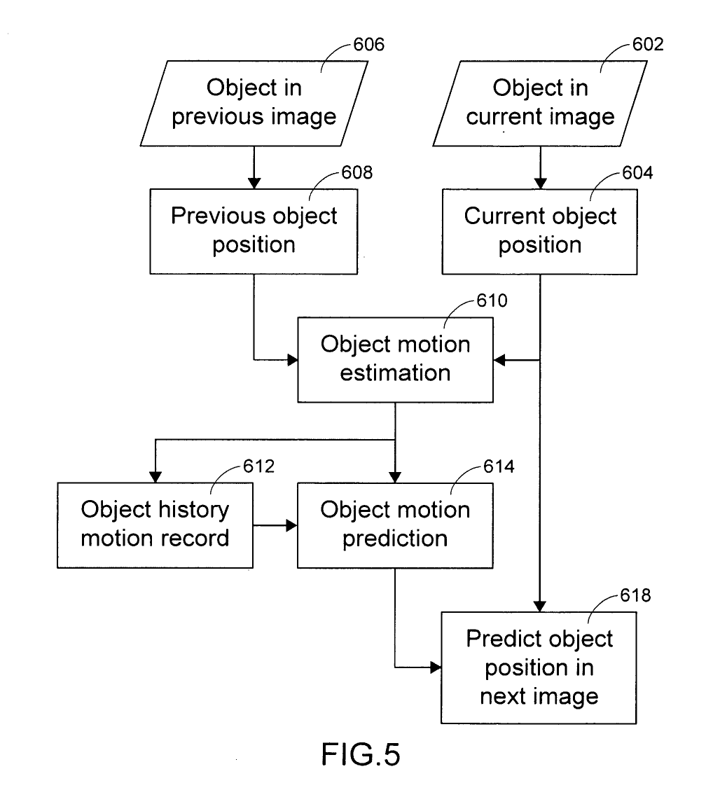

Please refer to FIG. 5, a flowchart illustrating a simple object prediction used for obtaining object motion information as explained above. At first, information of a specific object in the current image and previous image, provided by the object tracking element, is inputted (steps 602 and 606). The current object position Pos(Obj(k), t) and the previous object position Pos(Obj(k), t−1) are picked form the inputted information (steps 604 and 608). By comparing the two positions, the procedure calculates the current object motion MV(Obj(k), t) (step 610). In this embodiment, the term “motion” indicates a motion vector consisting of moving speed and moving direction. The object motion in the current and historical images is collected (step 612). Then, motion prediction function MP(Obj(k), t) is obtained by the calculation related to the object motion MV(Obj(k), t) and earlier object motion MV(Obj(k), t−1), MV(Obj(k), t−2), . . . (step 614). By adding the motion prediction function MP(Obj(k), t) to the current object position Pos(Obj(k), t), the procedure successfully predicts the object position Predict_pos(Obj(k), t+1) in the next image (step 618). These steps repeat till all the objects have the corresponding prediction information assisting in object segmentation as described above.

From the above description, the present feedback object detection method utilizes the prediction information of objects to facilitate the segmentation determination of the pixels. The variable threshold value flexibly adjusts the segmentation sensitivities along the entire image so as to increase the accuracy of object segmentation. The dilemma of neglecting noise or extracting all existing objects in the image resulted from fixed threshold value is thus solved. It is applicable to take advantage of this feedback object detection method in many fields including intelligent video surveillance system, computer vision, man-machine communication interface and image compression because of the high-level segmentation and detection ability.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A feedback object detection method, comprising steps of:
receiving a first image comprising an object;
receiving prediction information of the object
extracting the object from the first image according to the prediction information;
tracking the extracted object to generate motion information of the object; and
generating prediction information of the object corresponding to a second image later than the first image according to the motion information.

2. The feedback object detection method according to claim 1 wherein the prediction information indicates that a portion of pixels in the first image are predicted foreground pixels.

3. The feedback object detection method according to claim 2 wherein the extracting step further comprises a step of adjusting a threshold value for each pixel according to the prediction information to determine whether a selected pixel in the first image is a foreground pixel or a background pixel.

4. The feedback object detection method according to claim 3 wherein the adjusting step comprises steps of:
decreasing the threshold value when the selected pixel is one of the predicted foreground pixels; and
increasing the threshold value when the selected pixel is not one of the predicted foreground pixels.

5. The feedback object detection method according to claim 3 wherein the extracting step further comprises steps of:
comparing the first image with a background model to get a first difference for the selected pixel; and
determining the selected pixel is the foreground pixel when the first difference is greater than the threshold value.

6. The feedback object detection method according to claim 5 wherein the background model is a mixed Gaussian background model, a probability distribution background model, or a still background model.

7. The feedback object detection method according to claim 3 wherein the extracting step further comprises steps of:
comparing the selected pixel with the nearby pixels to get a second difference; and
determining the selected pixel is the foreground pixel when the second difference is greater than the threshold value.

8. The feedback object detection method according to claim 1, further comprising a step of calculating object information of the extracted object.

9. The feedback object detection method according to claim 8 wherein the object information is one selected from a group consisting of color distribution, center of mass, size and a combination thereof.

10. The feedback object detection method according to claim 9 wherein the extracted object is tracked according to the similarity of the object information between the first image and a third image earlier than the first image.

11. The feedback object detection method according to claim 1 wherein the motion information includes moving speed and moving direction of the tracked object.

12. A feedback object detection system for detecting an object in an image, comprising:
an object segmentation element for extracting the object from the first image according to prediction information;
an object tracking element for tracking the extracted object to generate motion information of the object; and
an object prediction element for generating the prediction information of the object according to the motion information.

13. The feedback object detection system according to claim 12 wherein the prediction information indicates that a portion of pixels in the image are predicted foreground pixels.

14. The feedback object detection system according to claim 13 wherein the object segmentation element adjusts a threshold value for each pixel according to the prediction information to determine whether a selected pixel in the image is a foreground pixel or a background pixel.

15. The feedback object detection system according to claim 14 wherein the object segmentation element decreases the threshold value when the selected pixel is one of the predicted foreground pixels, and increases the threshold value when the selected pixel is not one of the predicted foreground pixels.

16. The feedback object detection system according to claim 14 wherein the selected pixel is determined to be one of the foreground pixel and the background pixel according to a property of the selected pixel and the threshold value.

17. The feedback object detection system according to claim 12, further comprising an object acquisition element for calculating object information of the extracted object.

18. The feedback object detection system according to claim 17 wherein the object acquisition element performs a connected component labeling algorithm on the pixels determined as the foreground pixels to obtain the object information.

19. An object segmentation method for analyzing an image comprising a plurality of pixels, a portion of the pixels constituting an object, comprising steps of:
receiving prediction information of the object;
adjusting a segmentation sensitivity for each pixel according to the prediction information; and
for each pixel, determining whether the pixel is a foreground pixel or a background pixel according to a property of the pixel by considering the segmentation sensitivity corresponding to the pixel.

20. The object segmentation method according to claim 19 wherein the prediction information indicates that a first portion of the pixels are predicted foreground pixels, wherein the segmentation sensitivity of a selected pixel increases when the selected pixel is one of the predicted foreground pixels.
